(19) United States
(12) Patent Application Publication
(10) Pub. No.: US 2015/0147720 A1
(43) Pub. Date: May 28, 2015

(54) Tooth-Replacement Implant

(71) Applicant: Taipei Biotechnology Ltd., Taipei City (TW)

(72) Inventors: Wen-Fu LAI, Taipei City (TW); Chien-Chou LIN, Taipei City (TW); Mao-Suan HUANG, Taipei City (TW); Wu-Hsiung LIN, Taipei City (TW)

(21) Appl. No.: 14/319,262

(22) Filed: Jun. 30, 2014

(30) Foreign Application Priority Data
Nov. 25, 2013 (TW) 102222003

(51) Int. Cl. A61C 8/00

(52) U.S. Cl. CPC A61C 8/0037; A61C 8/0013; A61C 8/0075; A61C 2008/0046
USPC 433/173

(57) ABSTRACT

The present invention relates to a tooth-replacement implant, comprising: a main body portion and a root cervical portion, wherein the root body portion has a plurality of lateral pores and a hollow thorough hole at the bottom. Further, a collagen coating layer and an anti-bacterial coating layer are formed on the surface of the body portion root. Therefore, the present invention may increase bone contact area and enhance stability, and thereby avoiding compressing nerve to cause paralysis of perception through the implant and avoiding the sinus perforation.

### CROSS REFERENCE TO RELATED APPLICATION

This application claims the benefits of the Taiwan Patent Application Serial Number 102222003, filed on Nov. 25, 2013, the subject matter of which is incorporated herein by reference.

### BACKGROUND OF THE INVENTION

1. Field of the Invention

The present invention relates to a tooth-replacement implant, and more particularly to a tooth-replacement implant having a plurality of lateral pore and a hollow thorough hole at the bottom.

2. Description of Related Art

The number of the implants is up to 300,000 every year in Taiwan, and there are tens of products of the tooth-replacement implants in the market. The tooth-replacement implant is an endosseous implant, which is made generally from pure titanium or titanium alloy, and implanted in bones of upper arch or lower arch by an operation to provide a support for artificial tooth and recover a mastication function.

Besides, whether the operation of implant is successful or not, there are many reasons that we need to take into account, such as a sclerotin, a bone mass, a geometrical shape of the implant, surface properties and so on. Therefore, the osseointegration of the tooth-replacement implant in the alveolus and stability of the tooth-replacement implant under the load of mastication are quite important. As a result, many researches relate to the surface structure of the tooth-replacement implant and therapeutic methods to improve bone healing and stability of the implant in an early stage.

In the past, the tooth-replacement implant is mostly designed as an end part having a circular arc shape and an outer surface having a gradual microgroove, which is inserted correspondingly into cancellous bone of the alveolus bone. Besides, the tooth-replacement implant includes a crown part having an annular microgroove on its outer surface and a connecting hole; wherein the annular microgroove corresponds to cortical bone of the alveolus bone. However, the tooth-replacement implant having this structure makes an unnecessary destruction of dental tissue, and a hydrostatic pressure is produced to compress mandibular nerve or mental nerve when the implant is screwed, and thereby causing paralysis of perception, and even resulting in sinus perforation and sinus inflammation.

Therefore, a clinical request is urgent for a tooth-replacement implant, which can balance a pressure of tooth and avoid compressing nerve to improve stability, and thereby solving the well-known technical problems.

### SUMMARY OF THE INVENTION

An object of the present invention is to provide a tooth-replacement implant, which can disperse the produced hydrostatic pressure when the implant is screwed, and avoid compressing mandibular nerve or mental nerve, and thereby avoiding destroying the sinus membrane.

Another object of the present invention is to provide a tooth-replacement implant, on which a collagen or a long acting antibiotic can be coated. The coated collagen can improve surface hydrophilic, decrease microtrauma, and increase wound healing. Further, the coated long acting antibiotic can destroy pathological changes of roots or periodontal tissues, and can also increase bone contact area to promote stability.

To achieve the above object, the present invention provides a tooth-replacement implant, comprising: a main body portion having a microgroove portion and a circular arc groove portion on its outer surface; wherein the microgroove portion is located on the upper surface of the main body portion and the circular arc groove portion is located on the lower surface of the main body portion; and a root cervical portion having a tooth crown connecting portion and located on the top of the main body portion; wherein the main body portion can has a plurality of lateral pores located in circular arc groove portion and cutting through the outer surface and internal surface of the main body portion. Further, the main body portion can has a hollow thorough hole formed by extending upwards from the bottom of the main body portion and connecting these lateral pores.

In the tooth-replacement implant of the present invention, the hollow thorough hole of the tooth-replacement implant can increase about one fifth of bone contact area (bone-to-implant contact, BIC) to enhance stability of the tooth-replacement implant and bones. Thereby, the present invention can provide designs of the lateral pores and the hollow thorough hole of the tooth-replacement implant to increase bone contact area and enhance stability, and thereby avoiding compressing nerve to cause paralysis of perception through the implant and avoiding the sinus perforation.

In the tooth-replacement implant of the present invention, an outer surface of the main body portion can be an inclined surface, so that the microgroove portion has a bigger sectional area, and the circular arc groove portion has a smaller sectional area. In other words, the sectional area of the main body portion is reduced gradually from the microgroove portion toward circular arc groove portion to provide a design of a hollow thorough hole of the bottom of the tooth-replacement implant. Besides, in the aforementioned tooth-replacement implant, a profile of the main body portion can be a circular cylinder to be used as a the main body portion for back tooth, or a profile of the main body portion can be a cone to be used as the main body portion for anterior tooth.

In the tooth-replacement implant of the present invention, the number of the lateral pore of the main body portion may be randomly varied based on the user's requirements or the main body structure; wherein the main body portion may preferably include 2 to 5 of the lateral pore, more preferably, the main body portion may preferably include 3 of the lateral pores.

In the tooth-replacement implant of the present invention, the internal surface of the tooth crown connecting portion may have an internal microgroove portion for setting and fixing the tooth crown portion required to the tooth-replacement implant.

In the tooth-replacement implant of the present invention, the surface of the main body portion may have a collagen coating layer formed by a surface grafting method or an electrospinning method. First, the grafting method is that the main body portion is immersed in amide, and then the main body portion is immersed in collagen to form a collagen coating layer; wherein the collagen coating layer may be at least one selected from the group consisting of nano collagen, reconstituted collagen (R-collagen), electrospinning reconstituted collagen and combinations thereof. The reconstituted collagen is a collagen that is treated with pepsin and reconstituted with glutaraldehyde; wherein the aforementioned reconstituted collagen is obtained a Taiwan patent by the inventor of the present application, which is entitled “reconstituted collagen template and the process to prepare the same”, and the official patent certificate number is 171249. Besides, the reconstituted collagen was also obtained a United States patent; the official patent certificate number is U.S. Pat. No. 5,876,444; and it is entitled “collagen template as a joint regenerative material, the manufacture and its procedure”. Comparing to the natural collagen, the reconstituted collagen of the present invention has abilities of inducing organizations, cell regeneration and recovering. Further, the reconstituted collagen may be a nano reconstituted collagen, a fibril reconstituted collagen, or combination thereof. Therefore, the aforementioned collagen of the present invention may only be the nano reconstituted collagen, the fibril reconstituted collagen or a combination of the nano reconstituted collagen and the fibril reconstituted collagen, and then the aforementioned collagen is lyophilized. The used collagen of the present invention is only the fibril reconstituted collagen and the used percent by volume is preferable within 5˜10%.

Besides, in the tooth-replacement implant of the present invention, the collagen coating layer may improve surface hydrophilicity, decrease microtrauma, and increase wound healing Further, the reconstituted collagen is affected with the bones reserved in the hollow thorough hole, which may increase osseointegration and stability of the inside of the tooth-replacement implant.

In the tooth-replacement implant of the present invention, the surface of the main body part or the internal surface of the hollow thorough hole may have an anti-bacterial coating layer; wherein the anti-bacterial coating layer may be made of the long acting antibiotic to increase surface hydrophilicity and wound healing.

In the tooth-replacement implant of the present invention, the tooth-replacement implant further include a tooth crown portion capable of fixing to the root cervical portion and the main body portion through the connecting portion and the tooth connecting portion.

Therefore, the effects of the present are that the produced hydrostatic pressure is dispersed when screwing the tooth-replacement implant to avoid compressing mandibular nerve or mental nerve. Besides, the hollow thorough hole may be filled with the long acting antibiotic to destroy pathological changes of roots or periodontal tissues, and can also increase bone contact area to promote stability. To sum up, the feature of the present invention is a new design of a tooth-replacement implant according to particularities of the oral ecological condition.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a schematic diagram of a tooth-replacement implant of example 1 of the present invention.

FIG. 2 shows a schematic diagram of a bottom of a tooth-replacement implant of example 1 of the present invention.

FIG. 3 shows a sectional drawing of a tooth-replacement implant of example 1 of the present invention.

FIG. 4 shows a schematic diagram of a tooth-replacement implant of example 1 of the present invention.

### DETAILED DESCRIPTION OF THE PREFERRED EMBODIMENT

Hereinafter, the actions and the effects of the present invention will be explained in more detail via specific examples of the invention. However, these examples are merely illustrative of the present invention and the scope of the invention should not be construed to be defined thereby.

### EXAMPLE 1

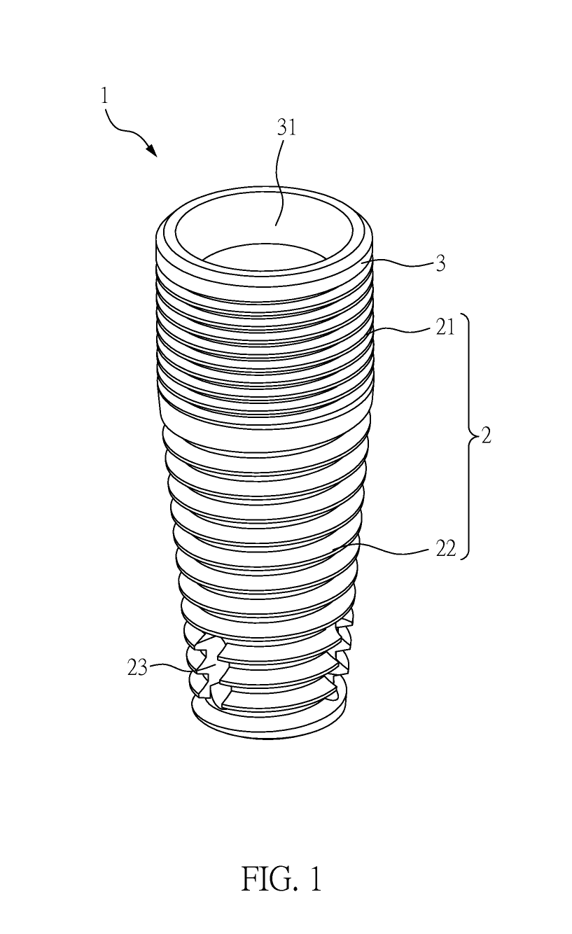

Please refer to FIG. 1, a schematic diagram of a tooth-replacement implant of example 1 of the present invention is shown. In the tooth-replacement implant of the present invention, the tooth-replacement implant includes a main body portion 2 having a microgroove portion 21 and a circular arc groove portion 22 on its outer surface; wherein the microgroove portion is located on the upper surface of the main body portion and has closer microgroove; and the circular arc groove portion 22 is located on the lower surface of the main body portion 2 and has farther coarse groove and the root cervical portion 3. The root cervical portion 3 has a tooth crown connecting portion 31, and the root cervical portion 3 is located on the top of the main body portion 2; wherein the main body portion 2 has three lateral pores 23 located on the circular arc groove portion 22 and cut through the outer surface and internal surface of the main body portion. The main body portion 2 has the hollow thorough hole (not shown) formed by extending upwards from the bottom of the main body portion 2 and connecting these lateral pores 23. The design of the hollow thorough hole may let bones reserve in the hollow thorough hole, so that the bone contact area of bones and the main body portion 2 as well as bones and the hollow thorough hole become large, and the more tissues are reserved to increase osseointegration and stability.

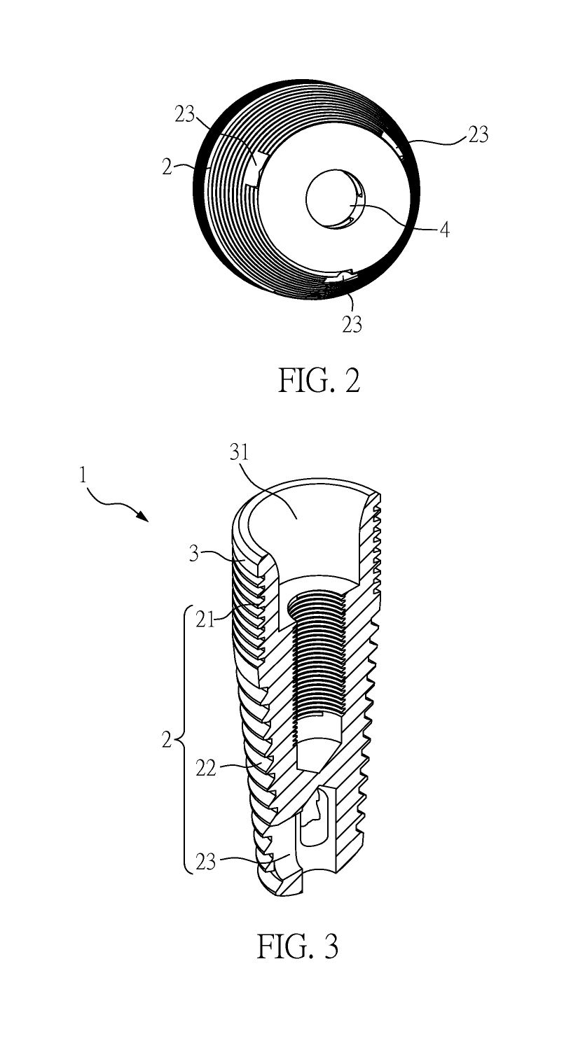

The example 1 of the present invention is that a collagen coating layer is formed on the tooth-replacement implant 1 by a surface grafting method. First, the tooth-replacement implant 1 is immersed in amide, and then the collagen type I from a cow is treated with pepsin and reduced with β-mercaptoetnanal to form a α-helix structure. Further, a composite is formed by recombining with glutaraldehyde, and the composite is the reconstituted collagen. Furthermore, the composite is dissolved in an acetic acid to obtain a reconstituted collagen solution. Finally, the tooth-replacement implant 1 is immersed in the obtained reconstituted collagen solution to form a collagen coating layer (not shown) on the surface of the tooth-replacement implant 1. Please refer to FIG. 1, the formed collagen coating layer may be formed on the surface of the tooth-replacement implant 1, such as the root neck portion 3, the main body portion 2, the microgroove portion 21, the circular arc groove portion 22 and the lateral pore 23. Further, please refer to FIGS. 2 and 3 together, FIG. 2 is a schematic diagram of a bottom of a tooth-replacement implant of example 1 of the present invention, and FIG. 3 is a sectional drawing of a tooth-replacement implant of example 1 of the present invention; wherein the bottom of the tooth-replacement implant 2 is a circular shape and has a hollow thorough hole 4 formed by extending upwards from the bottom of the main body portion 2 and connecting these lateral pores. Besides, a collagen coating layer is also formed on the surface of the tooth-replacement implant 1, such as the collagen coating layer is formed on the internal surfaces of the lateral pore 23 and a hollow thorough hole 24.

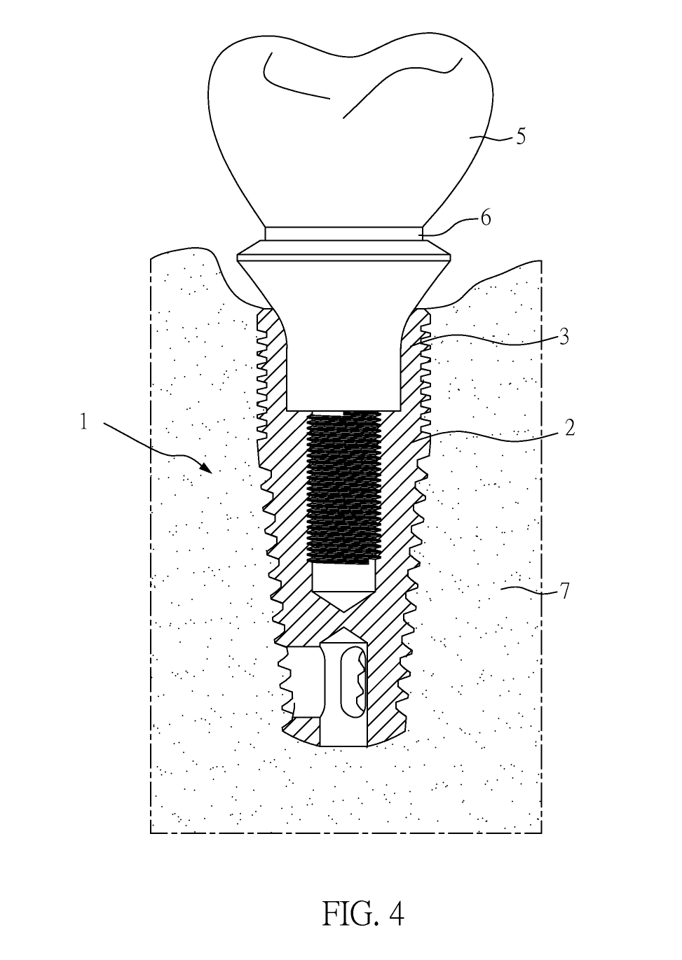

Then please refer to FIG. 4, a schematic diagram of a tooth-replacement implant of example 1 of the present invention is shown, in which a tooth crown portion is further set on the top of the root cervices. The tooth-replacement implant comprises a tooth crown 5, a connecting portion 6, a tooth-replacement implant 1 and an alveolar bone 7; wherein the tooth crown 5 is fixed on the root cervical portion 3 and the main body portion 2 by the connecting portion 6 and the tooth crown connecting portion 31, please refer to FIG. 1.

### EXAMPLE 2

The tooth-replacement implant of Example 2 is substantially the same as the above Example 1 and a method for manufacturing the reconstituted collagen solution of Example 2 is the same as above Example 1. The differences between Example 1 and Example 2 are that the collagen coating layer is formed on the tooth-replacement implant by the surface grafting method in Example 1, but the collagen coating layer is formed on the tooth-replacement implant by the electrospinning method and lyophilized it in Example 2.

### EXAMPLE 3

The tooth-replacement implant of Example 3 is substantially the same as the above Example 1, and the collagen coating layer is formed on the surfaces the tooth-replacement implant the same as the above Example 1. The difference between Example 1 and Example 3 is that an anti-bacterial coating layer further formed on the surface of the tooth-replacement implant in Example 3. In Example 3, a dipping solution is prepared by the long acting antibiotic, and the tooth-replacement implant with the collagen coating layer is immersed in the long acting antibiotic solution, so that the anti-bacterial coating layer is coated on the surface of the tooth-replacement implant. Besides, the surface hydrophilic may be improved and wound healing may be increased by the anti-bacterial coating layer to destroy pathological changes of roots or periodontal tissues.

### EXAMPLE 4

The tooth-replacement implant of Example 4 is substantially the same as the above Example 1, except that a profile of the main body portion is different. In Example 1, a profile of the main body portion to be a circular cylinder is used for back tooth, but in Example 4, a profile of the main body portion to be a cone is used for anterior tooth, and designs of the others are the same as the above Example 1. Further, the tooth-replacement implant of Example 4 is used the surface grafting method. First, the tooth-replacement implant is immersed in the amide solution. Second, a reconstituted collagen solution is prepared by the same manufacturing method as the above Example 1, and then the tooth-replacement implant is immersed in the reconstituted collagen solution, so that a collagen coating layer is formed on the tooth-replacement implant. The structure of the tooth-replacement implant of Example 4 is used for human's anterior tooth according to particularities of the oral ecological condition. This structure may decrease effects of undercut between alveolar bone and labial vestibule and the adjacent roots too bent, which is in favor of immediate implantation. Besides, the structure of the Example 1 of the present invention to be a circular cylinder is used for human's back tooth, which can increase vertical and lateral forces of occlusion to disperse the produced hydrostatic pressure when screwing the tooth-replacement implant, and the Example 4 of the present invention further avoid compressing mandibular nerve and mental nerve, and thereby causing paralysis of perception.

According to the structure of the tooth-replacement implant 1 of the present invention, the surface hydrophilic can be improved and microtrauma can be decreased to increase wound healing because of coating with collagen layer. Besides, the formation of the anti-bacterial coating layer can minimize pathological changes of roots or periodontal tissues. The design of the structure may also increase one fifth of bone contact area, and enhance stability between tooth and bones. According to the design of the coronal microgroove, a cortical bone contact area may be increased, an immediate stability may be improved, and the absorption of cortical bone may be decreased.

It should be understood that these examples are merely illustrative of the present invention and the scope of the invention should not be construed to be defined thereby, and the scope of the present invention will be limited only by the appended claims.

1. A tooth-replacement implant, comprising:
a main body portion having a microgroove portion and a circular arc groove portion on its outer surface, which the microgroove portion is located on a top surface of the main body portion and the circular arc groove portion is located on the bottom surface of the main body portion; and
a root cervical portion having a crown connecting portion and located on the top of the main body portion;
wherein the main body portion has a plurality of lateral pores which are located on the circular arc groove portion and cuts through an outer surface and an internal surface of the main body portion, and the main body portion has a hollow thorough hole which is formed by extending upwards from the bottom of the main body portion and connecting these lateral pores;
wherein the surface of the main body portion has a collagen coating layer.

2. The tooth-replacement implant of claim 1, wherein the outer surface of the main body portion is an inclined plane, so that the microgroove portion has a bigger sectional area, and the circular arc groove portion has a smaller sectional area.

3. The tooth-replacement implant of claim 1, wherein a profile of the main body portion is a circular cylinder or a cone.

4. The tooth-replacement implant of claim 1, wherein the main body portion has 3 of lateral pores.

5. The tooth-replacement implant of claim 1, wherein an internal surface of the crown connecting portion has an internal groove portion.

6. (canceled)

7. The tooth-replacement implant of claim 1, wherein the collagen coating layer is formed by a surface grafting method or an electrospinning method and lyophilized it.

8. The tooth-replacement implant of claim 1, wherein the collagen coating layer is selected from the group consisting of nano collagen, reconstituted collagen, electrospinning reconstituted collagen and combinations thereof.

9. The tooth-replacement implant of claim 1, wherein the surface of the main body portion or internal surface of the hollow thorough portion have an anti-bacterial coating layer.

10. The tooth-replacement implant of claim 9, wherein the anti-bacterial coating layer is made from an acting antibiotic.

11. The tooth-replacement implant of claim 1, further comprising a crown portion, which is fixed to the root cervical portion and the main body portion through a connecting portion and the crown connecting portion.
